(19) United States
(12) Patent Application Publication
(10) Pub. No.: US 2015/0245359 A1
(43) Pub. Date: Aug. 27, 2015

(54) METHOD AND APPARATUS OF SELECTING TRANSMISSION RATE IN WIRELESS TRANSMISSION SYSTEM

(71) Applicant: Electronics and Telecommunications Research Institute, Daejeon (KR)

(72) Inventors: Igor KIM, Daejeon (KR); Gwang Zeen KO, Daejeon (KR); Jin Hyung OH, Daejeon (KR); Hyun Duk KANG, Gwangju (KR); Myung Sun SONG, Daejeon (KR)

(21) Appl. No.: 14/445,439

(22) Filed: Jul. 29, 2014

(30) Foreign Application Priority Data
Feb. 24, 2014 (KR) 10-2014-0021537

(51) Int. Cl. H04W 72/06; H04W 24/10; H04L 1/00; H04W 72/08

(52) U.S. Cl. CPC H04W 72/06; H04W 72/087; H04W 24/10; H04L 1/0003

(57) ABSTRACT

A method and apparatus of selecting a transmission rate in a wireless transmission system are provided. The method of selecting a transmission rate by a transmission rate selecting apparatus may comprise assigning a weight to each of criteria for selecting a transmission rate per service class, calculating a score for each transmission rate per service class using statistics information collected for a plurality of transmission rates based on the weight-assigned criteria, and selecting a transmission rate for a service class based on the calculated score.

### CROSS-REFERENCE TO RELATED APPLICATION

Priority to Korean patent application number 2014-0021537 filed on Feb. 24, 2014, the entire disclosure of which is incorporated by reference herein, is claimed.

### BACKGROUND OF THE INVENTION

1. Technical Field

Embodiments of the present invention concern a method and apparatus of selecting the optimal transmission rate per service class to achieve the best performance in QoS (Quality of Service) aware wireless networks.

2. Discussion of Related Art

Wireless networks have become one of the major schemes to access end user data due to low costs and high-speed connectivity. As more and more devices are equipped with a wireless network interface, demand for wireless networks is quickly increasing. Accordingly, development of applications, as well as smart devices, becomes more critical to satisfy end users' demand. Each application has its own requirements in view of QoS (Quality of Service) parameters, such as, e.g., throughput, delay, jitter, and frame loss rate.

In typical wireless networks, each terminal and access point (AP) or base station (BS) should sync transmission rate (for example, MCS (Modulation and Coding Scheme)) so as to successfully decode received signals. In this case, the optimal transmission rate may vary depending on channel conditions between the transmitter and the receiver.

In a free-space propagation mode, the distance between the transmitter and the receiver is a major factor that affects channel quality. FIG. 1 shows a typical wireless network considering the free-space propagation mode. A mobile station (MS) 121 located near an AP 110 performs data transmission and reception using a high transmission rate corresponding to as high an MCS index (MCS M) as possible. Here, M is a natural number. As the MCS index increases, a frame error is more likely to occur. However, since the MS 121 is located at a sufficient close distance from the AP 110, the MS 121 may decode signals coming from the AP 110 without errors. In contrast, an MS 122 located far away from the AP 110 should use the minimum transmission rate corresponding to the minimum MCS index (MCS 0) in order to successfully transmit and receive signals.

However, since a signal may propagate through a wall or human body, the scenario illustrated in FIG. 1 is not a common case. In some cases, the signal level may be significantly decreased due to an obstacle such as wall even when the transmitter is located close to the receiver. Accordingly, the awareness of the physical distance between the MS and the AP is not a solution to selection the optimal transmission rate in an actual scenario.

Meanwhile, the transmitter should be aware of the level of a signal received from the receiver in order to select a proper MCS. The receiver may inform the level of received signal to the transmitter by sending feedback information to the transmitter. However, instability of wireless channel may cause frequent updating, thus inducing high overload. Accordingly, sending feedback information is not a solution either.

Typically, a transmission rate is selected considering throughput that is a major factor in determining the transmission rate. An MCS with the maximum throughput is generally optimal for frame transmission. However, although throughput is a major parameter that needs to be taken into account during the course of selecting transmission rate for some applications, delay, frame loss rate, or other parameters should be considered as well. Further, in a QoS-aware wireless network, selecting the optimal transmission rate considering a certain traffic class and its requirements is very critical. In such scenario, the traditional maximum throughput-based approach is not always the best solution.

In the meantime, Korean Patent Application Publication No. 10-2008-0071469 (published on Aug. 4, 2008), titled “method of selecting MCS index according to channel environments and transmitter for the same,” discloses enhancing transmission rate by selecting an MCS index having a coding rate of a predetermined coding rate threshold or more when the transmission end assigns resources in a local assignment manner and selecting an MCS index having a coding rate lower than the predetermined coding rate threshold when the transmission end assigns resources in a distributed assignment manner. However, such scheme merely selects an MCS index according to a resource assigning scheme and does not choose a transmission rate considering requirements per service class.

### SUMMARY OF THE INVENTION

An object of the present invention is to provide a method and apparatus of selecting a transmission rate in a wireless transmission system that may select the optimal transmission rate for different classes of an application according to the current network conditions and input criteria.

Another object of the present invention is to provide a method and apparatus of selecting a transmission rate in a wireless transmission system that may select the optimal transmission rate even without receiving any feedback from a destination node.

Still another object of the present invention is to provide a method and apparatus of selecting a transmission rate in a wireless transmission system that may be simply applicable to a typical network even without changing hardware.

According to an aspect of the present invention, a method of selecting a transmission rate by a transmission rate selecting apparatus may comprise assigning a weight to each of criteria for selecting a transmission rate per service class, calculating a score for each transmission rate per service class using statistics information collected for a plurality of transmission rates based on the weight-assigned criteria, and selecting a transmission rate for a service class based on the calculated score.

In an aspect, the criteria may include a throughput, a delay, a frame loss, and a jitter.

In another aspect, the criteria may include at least one of a received signal strength, a power consumption constraint, and a user defined preference.

In still another aspect, the weight may be estimated based on a degree of importance of a criterion with respect to another criterion.

In yet still another aspect, the statistics information may be collected based on a trial frame transmitted during data transmission.

In yet still another aspect, the trial frame may be transmitted at a different transmission rate from a transmission rate of a normal frame.

In yet still another aspect, the trial frame may be part of a frame carrying the data.

In yet still another aspect, the statistics information may include at least one of a frame loss rate, a delay, a throughput, and a retransmissions number for a corresponding frame.

In yet still another aspect, when the statistics information is not collected, the transmission rate per service class may be set as an initial transmission rate estimated based on the estimated weight.

In yet still another aspect, the transmission rate per service class may be set as an MCS index corresponding to ½ of the total number of MCS (Modulation and Coding Scheme) indexes when the statistics information is not collected.

According to another aspect of the present invention, an apparatus of selecting a transmission rate may comprise a weight assigning unit assigning a weight to each of criteria for selecting a transmission rate per service class, a score calculating unit calculating a score for each transmission rate per service class using statistics information collected for a plurality of transmission rates based on the weight-assigned criteria, and a transmission rate selecting unit selecting a transmission rate for a service class based on the calculated score.

In QoS-aware wireless network, requirements per service class are considered based on a plurality of criteria, thus the optimal transmission rate can be selected in a simple and efficient manner.

Statistics for different transmission rates may be collected using test frames, so that the optimal transmission rate may be selected even without receiving any feedback information from a destination node.

According to the present invention, an apparatus of selecting a transmission rate may be implemented in software modules in a driver for an existing hardware interface, and thus, may be simply embedded in a typical network even without changing hardware.

### BRIEF DESCRIPTION OF DRAWINGS

FIG. 1 is a view illustrating a typical wireless network considering a free-space propagation mode;

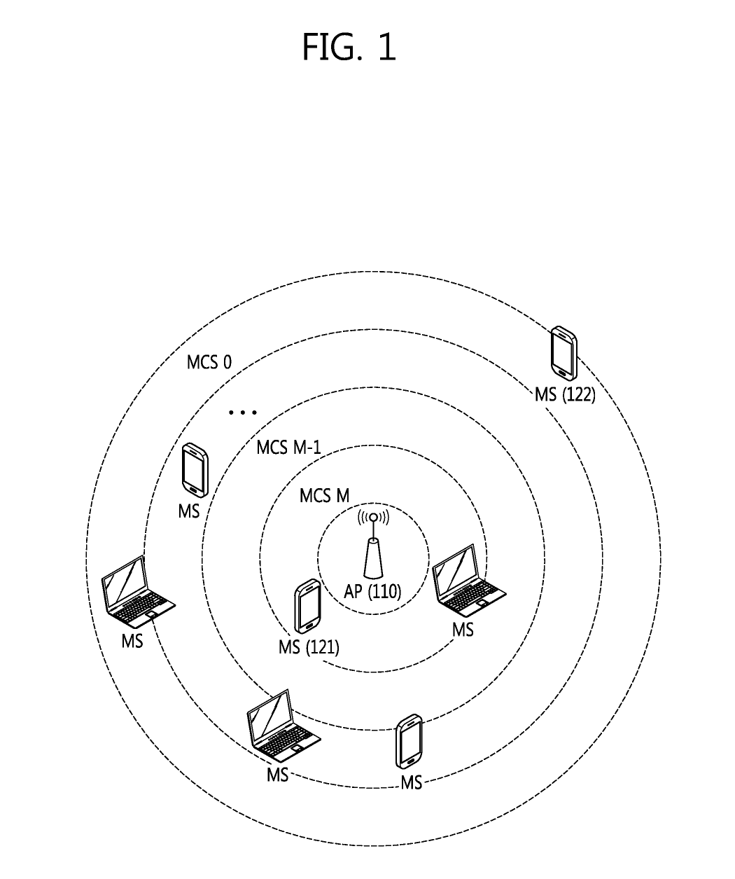

FIG. 2 is a view illustrating a process of hierarchically selecting a transmission rate based on a plurality of criteria according to an embodiment of the present invention;

FIG. 3 is a block diagram illustrating an apparatus of selecting a transmission rate according to an embodiment of the present invention; and

FIG. 4 is a flowchart illustrating a method of selecting a transmission rate for an optimal transmission rate according to an embodiment of the present invention.

### DETAILED DESCRIPTION OF EMBODIMENTS

Hereinafter, embodiments of the present invention are described below in detail with reference to the accompanying drawings so that the embodiments can be easily practiced by one of ordinary skill in the art. However, various changes may be made without being limited thereto. What is irrelevant to the present invention was skipped from the description for clarity, and like reference denotations are used to refer to like or similar elements throughout the specification.

As used herein, when an element “includes” another element, the element may further have the other element unless stated otherwise. As used herein, the term “unit” denotes a unit of performing at least one function or operation and may be implemented in hardware, software, or a combination thereof.

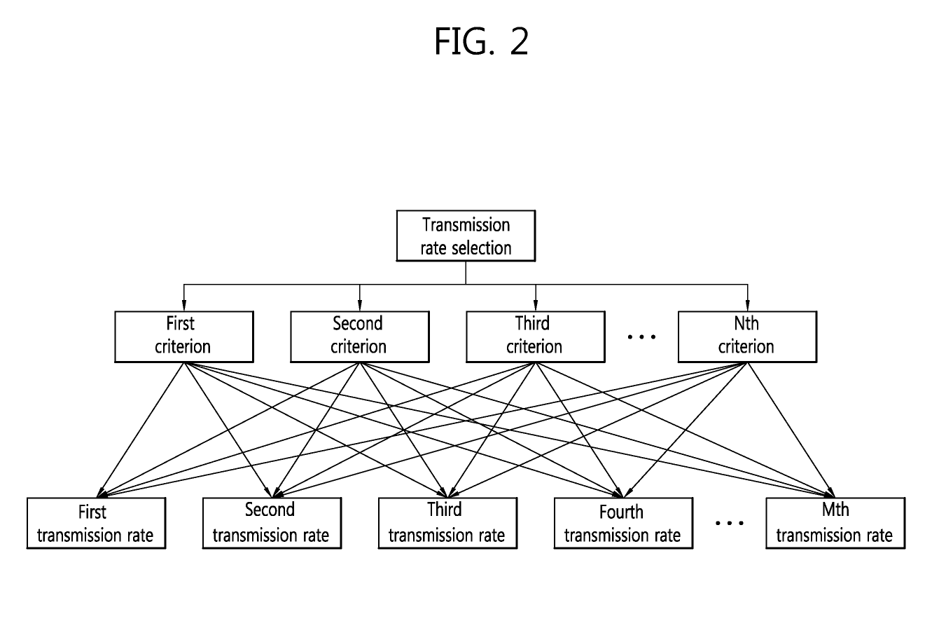

FIG. 2 is a view illustrating a process of hierarchically selecting a transmission rate based on a plurality of criteria.

A typical QoS (Quality of Service) aware wireless network has a plurality of traffic types that are classified into different service classes according to QoS. Table 1 below represents existing service classes per wireless network.

TABLE 1

| Service class | IEEE 802.11 | IEEE 802.16 | 3GPP LTE |
|---|---|---|---|
| C₁ | Voice | IGS, ertPS | Conversational |
| C₂ | Video | rtPS | Streaming |
| C₃ | Best Effort | BE | Interactive |
| C₄ | Background | nrtPS | Background |

The first service class (C₁) corresponds to a real-time conversational voice or network management data. The application for the first service class is a VoIP (Voice of IP). VoIP traffic is robust against loss but is sensitive to delay and jitter. Meanwhile, the second service class (C₂) is more sensitive to throughput as compared with the first service class. The second service class typically corresponds to a video conference or streaming media. Sine a network error may be compensated by a higher-layer error correction technique, the frame loss rate for the second service class is less critical. As compared with the first service class and the second service class, the application for the third service class (C₃) is further sensitive to frame loss. Web browsing and FTP file transmission are two examples of the third service class. Typically, such application is a TCP-based one that causes all frame losses to induce a lowering in throughput. Further, some frame loss for the third service class cannot be compensated by a higher-layer error correction technique. The fourth service class (C₄) is an application that is primarily run on the background. An example is FAXing. In the fourth service class, frame loss rate is critical as compared with throughput or delay.

Accordingly, the apparatus of selecting a transmission rate according to the present invention selects a transmission rate through a hierarchical process based on a plurality of criteria. The hierarchical process may be generated for all service classes C={C₁, C₂, . . . , C_{L}}. Here, L refers to the number of service classes. Based on the set of the criteria, Cr={Cr₁, Cr₂, Cr₃, . . . , Cr_{N}}, the optimal transmission rate is selected from the set of transmission rates R={R₁, R₂, R₃, . . . , R_{M}}. Here, N denotes the total number of criteria, and M denotes the total number of transmission rates.

Table 2 represents criteria that may be used in the hierarchical process shown in FIG. 2. Referring to Table 2, each wireless network has different denotations for traffic characteristics and such traffic characteristics are used as criteria for selecting a transmission rate.

TABLE 2

| Criteria | IEEE 802.11 | IEEE 802.16 | 3GPP LTE |
|---|---|---|---|
| C₁ | Peak data rate | Maximum sustained | Maximum bit rate |
| | | traffic rate | |
| C₂ | Minimum data rate | Minimum reserved | Guaranteed bit rate |
| | | traffic rate | |
| C₃ | Packet error rate | Packet error rate | SDU error ratio |
| C₄ | Delay bound | Latency | Transfer delay |
| C₅ | Jitter | Tolerated jitter | Delay variation |

The criteria shown in Table 2 are merely an example, and a method of selecting a transmission rate according to the present invention may, upon determining a transmission rate, use a received signal strength, power consumption constraint, or user defined preference, as well as the criteria shown in Table 2.

Meanwhile, Table 3 represents MCS (Modulation and Coding Scheme) and transmission rates used in IEEE 802.11n wireless LAN.

TABLE 3

| MCS index | Modulation | Coding Rate | Date Rate |
|---|---|---|---|
| 0 | BPSK | 1/2 | 6.5 Mbit/s |
| 1 | QPSK | 1/2 | 13.0 Mbit/s |
| 2 | QPSK | 3/4 | 19.5 Mbit/s |
| 3 | 16QAM | 1/2 | 26.0 Mbit/s |
| 4 | 16QAM | 3/4 | 39.0 Mbit/s |
| 5 | 64QAM | 2/3 | 52.0 Mbit/s |
| 6 | 64QAM | 3/4 | 58.5 Mbit/s |
| 7 | 64QAM | 5/6 | 65.0 Mbit/s |

Referring to Table 3, the lowest MCS index (MCS index 0) provides the lowest transmission rate but may repair most of errors. In contrast, the highest MCS index (MCS index 7) provides the highest transmission rate but the lowest error restoration.

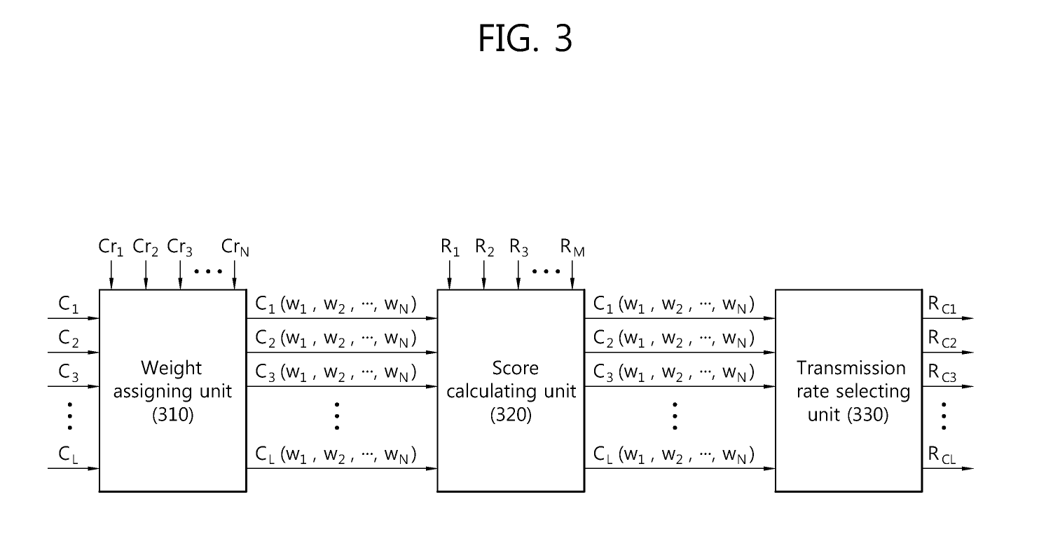

FIG. 3 is a block diagram illustrating an apparatus of selecting a transmission rate according to an embodiment of the present invention. Referring to FIG. 3, the apparatus of selecting a transmission rate according to the present invention includes a weight assigning unit 310, a score calculating unit 320, and a transmission rate selecting unit 330. According to the present invention, the transmission rate selecting apparatus may be implemented in software modules in a driver for an existing hardware interface, and as an example, may be included in a transmitter configuring a wireless network.

The weight assigning unit 310 estimates weights that are applied to criteria (Cr₁, Cr₂, Cr₃, . . . , Cr_{N}) for selecting a transmission rate per service class. The weight assigning unit 310 assigns the estimated weights to the criteria. Input parameters for estimating weights include L service classes (C₁, C₂, . . . , C_{L}), N criteria (Cr₁, Cr₂, Cr₃, . . . , Cr_{N}), and a criterion-related table. Table 4 represents an example of the criterion-related table.

TABLE 4

| Criteria | Throughput | Delay | Frame loss | Jitter |
|---|---|---|---|---|
| Throughput | 1 | a | b | c |
| Delay | 1/a | 1 | d | e |
| Frame loss | 1/b | 1/d | 1 | f |
| Jitter | 1/c | 1/e | 1/f | 1 |

Referring to Table 4, the criterion-related table represents the degree of importance of one criterion with respect to another criterion in an absolute value. For example, the throughput in the first row is a times more critical as compared with delay, b times more critical as compared with frame loss, and c times more critical as compared with jitter. The other rows in the criterion-related table follow the same rules. Since the same criteria have the same degree of importance, the values along the diagonal line of the criterion-related table are all 1's. According to the present invention, the transmission rate selecting apparatus may estimate the final weight for each criterion per service class by using other approaches used for comparison between metric pairs or geometric mean and arithmetic mean based on the relations between the criteria as shown in Table 4.

The score calculating unit 320 calculates a score for each transmission rate per service class using statistics information collected for the plurality of transmission rates based on N weight-assigned criteria (w₁, w₂, . . . , w_{N}). Here, all transmission rates (R1, R2, R2, . . . , R_{M}) are used as additional input variables for evaluating the score for each transmission rate together with the statistics information collected for all the transmission rates. As an example, the statistics information may be collected for all the transmission rates based on a trial frame transmitted during data transmission. The trial frame may be part of a frame carrying data and may be transmitted in a different transmission rate from that of a normal frame. The statistics information may contain at least one of frame loss rate, delay, throughput, and retransmissions number.

The transmission rate selecting unit 330 selects the optimal transmission rate per service class based on a score calculated by the score calculating unit 320. At this time, the transmission rate evaluated to have the maximum score is chosen as the optimal transmission rate. However, a transmission rate having a lower score may be considered as a potential rate for frame transmission.

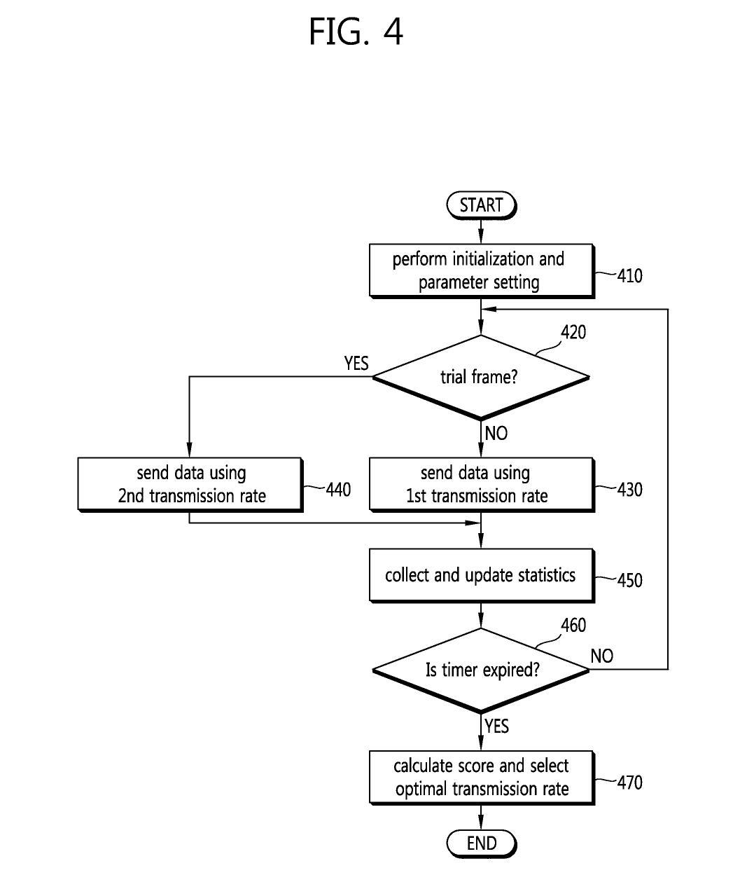

FIG. 4 is a flowchart illustrating a method of selecting an optimal transmission rate according to an embodiment of the present invention.

The transmission rate selecting apparatus first performs initialization and parameter setting in order to transmit data at the optimal transmission rate (step 410). Specifically, the transmission rate selecting apparatus estimates a weight for each criterion per service class as shown in FIG. 3 at the initial step and assigns the estimated weight to its respective criterion while selecting an initial transmission rate for each service class. At this time, since no statistics on transmission rate is collected at the initial step, the initial transmission rate for all the service classes may be set as an MCS index (M/2) corresponding to ½ of the total number of MCS indexes. Such setting may provide for quick convergence to the optimal transmission rate. However, the transmission rate selecting apparatus according to the present invention may also select the initial transmission rate based on the estimated weight.

Meanwhile, the transmission rate selecting apparatus may set a timer before transmission of an initial frame. The timer is used to trigger statistics update. The timer is rescheduled after updating each statistic. The timer value may be selected to be small enough to be able to react with a sudden change in the channel state and may be selected to be high enough to be able to collect other statistics different from those of the currently selected transmission rate. At this time, the interval at which the statistics are updated may be selected considering the consistency of channels dependent upon environmental conditions and access techniques.

Further, the frame may not be always transmitted at the optimal transmission rate selected. Part of the frame may be transmitted at a different transmission rate from the currently selected transmission rate. Such frame is called a trial frame. The frame may be subjected to determination as to whether the frame is a normal frame or trial frame, before transmitted (step 420). In case the frame to be sent is a normal frame, the frame may be transmitted at a first transmission rate (step 430). However, in case the frame to be transmitted is determined to be a trial frame, the frame may be sent at a second transmission rate (step 440). At this time, part of the trial frame should not be larger than part of the normal frame. In case the part of the trial frame is larger than the part of the normal frame, the performance may be decreased. However, the part of the trial frame should be larger enough to be able to obtain statistics necessary for other transmission rate. The statistics information associated with each transmission rate may include frame loss rate, delay, throughput, and retransmissions number or other criteria used for weight estimation.

The transmission rate selecting apparatus, when the statistics information is collected, updates the statistics information (step 450), and when the timer is expired (step 460), calculates a score for each transmission rate based on the collected statistics information to thus select an optimal transmission rate (step 470).

Although the present invention has been shown and described in connection with embodiments thereof, it will be understood by those of ordinary skill in the art that various changes in form or detail may be made thereto without departing from the scope of the present invention defined by the following claims.

What is claimed is:

1. A method of selecting a transmission rate by a transmission rate selecting apparatus, the method comprising:
assigning a weight to each of criteria for selecting a transmission rate per service class;
calculating a score for each transmission rate per service class using statistics information collected for a plurality of transmission rates based on the weight-assigned criteria; and
selecting a transmission rate for a service class based on the calculated score.

2. The method of claim 1, wherein the criteria include a throughput, a delay, a frame loss, and a jitter.

3. The method of claim 1, wherein the criteria include at least one of a received signal strength, a power consumption constraint, and a user defined preference.

4. The method of claim 1, wherein the weight is estimated based on a degree of importance of a criterion with respect to another criterion.

5. The method of claim 1, wherein the statistics information is collected based on a trial frame transmitted during data transmission.

6. The method of claim 5, wherein the trial frame is transmitted at a different transmission rate from a transmission rate of a normal frame.

7. The method of claim 5, wherein the trial frame is part of a frame carrying the data.

8. The method of claim 1, wherein the statistics information includes at least one of a frame loss rate, a delay, a throughput, and a retransmissions number for a corresponding frame.

9. The method of claim 1, wherein when the statistics information is not collected, the transmission rate per service class is set as an initial transmission rate estimated based on the weight.

10. The method of claim 1, wherein the transmission rate per service class is set as an MCS index corresponding to ½ of the total number of MCS (Modulation and Coding Scheme) indexes when the statistics information is not collected.

11. An apparatus of selecting a transmission rate, comprising:
a weight assigning unit assigning a weight to each of criteria for selecting a transmission rate per service class;
a score calculating unit calculating a score for each transmission rate per service class using statistics information collected for a plurality of transmission rates based on the weight-assigned criteria; and
a transmission rate selecting unit selecting a transmission rate for a service class based on the calculated score.

12. The apparatus of claim 11, wherein the criteria include a throughput, a delay, a frame loss, and a jitter.

13. The apparatus of claim 11, wherein the criteria include at least one of a received signal strength, a power consumption constraint, and a user defined preference.

14. The apparatus of claim 11, wherein the weight assigning unit assigns the weight based on a degree of importance of a criterion with respect to another criterion.

15. The apparatus of claim 11, wherein the statistics information is collected based on a trial frame transmitted during data transmission.

16. The apparatus of claim 15, wherein the trial frame is transmitted at a different rate from a transmission rate of a normal frame.

17. The apparatus of claim 15, wherein the trial frame is part of a frame carrying the data.

18. The apparatus of claim 11, wherein the statistics information includes at least one of a frame loss rate, a delay, a throughput, and a retransmissions number for a corresponding frame.

19. The apparatus of claim 11, wherein the transmission rate selecting unit selects a transmission rate for the service class as an initial transmission rate estimated based on the weight when the statistics information is not collected.

20. The apparatus of claim 11, wherein the transmission rate selecting unit selects a transmission rate for the service class as an MCS (Modulation and Coding Scheme) index corresponding to ½ of the total number of MCS indexes when the statistics information is not collected.
